(19) United States
(12) Patent Application Publication
(10) Pub. No.: US 2015/0158431 A1
(43) Pub. Date: Jun. 11, 2015

(54) SPORTS BOARD MOUNTS AND STRUCTURES AND METHODS INCLUDING THE SAME

(71) Applicant: Samson Sports, LLC, Camas, WA (US)

(72) Inventors: Scott D. Parnell, Camas, WA (US); Kevin E. Fredrickson, Salem, OR (US)

(21) Appl. No.: 14/565,022

(22) Filed: Dec. 9, 2014

Related U.S. Application Data
(60) Provisional application No. 61/913,510, filed on Dec. 9, 2013.

(51) Int. Cl. B60R 9/08; F16M 11/00; F16M 13/02

(52) U.S. Cl. CPC B60R 9/08; F16M 13/02; F16M 11/00

(57) ABSTRACT

Sports board mounts and structures and methods including the same. In one embodiment, the sports board mount includes a body configured to receive the sports board, two laterally spaced-apart clamping members, and an actuator. The clamping members are configured to be selectively moved relative to the body to operatively engage and retain the sports board. The actuator is operatively coupled to the clamping members and configured to selectively move the clamping members. In another embodiment, the sports board mount includes a body that includes a base, a first upper arm, a first lower arm, a second upper arm, and a second lower arm. This sports board mount further includes a first clamping member, a second clamping member, and an upper actuator configured to selectively move both the first clamping member and the second clamping member. The methods include methods of retaining the sports board within the sports board mounts.

### RELATED APPLICATION

This application claims priority under 35 U.S.C. §119(e) to U.S. Provisional Patent Application No. 61/913,510, which was filed on Dec. 9, 2013, and the complete disclosure of which is hereby incorporated by reference.

### FIELD

The present application relates to sports board mounts and to structures and methods that include and/or utilize the sports board mounts.

### BACKGROUND

Sports boards may include wake boards, wake surf boards, surf boards, windsurfing boards, water skis, snow skis, snowboards, skateboards, and the like. Sports boards may be utilized in a variety of different activities, including watersports, snow sports, and/or overland sports. Often, it may be desirable to operatively retain a sports board when the sports board is not in use. As an example, the sports board may be operatively retained during transport of the sports board. As another example, the sports board may be operatively retained when another sports board is being utilized.

With this in mind, a sports board mount may operatively retain the sports board to a structure, such as to a watercraft, a vessel, a boat, a ship, a vehicle, a nonstationary vehicle, an automobile, an off road vehicle, a recreational vehicle, and/or an aircraft. However, conventional sports board mounts often are difficult to use, are not capable of accommodating sports boards of varying dimensions, may not securely retain the sports board, may damage certain sports boards, and/or may require an operator to perform several distinct actions to operatively retain the sports board and/or to remove the sports board. Thus, there exists a need for improved sports board mounts, as well as for improved structures that include the improved sports board mounts and/or methods of operating the improved sports board mounts.

### SUMMARY

Sports board mounts and structures and methods including the same. In one embodiment, the sports board mount includes a body configured to receive the sports board and to be operatively coupled to a structure, such as a land vehicle or a watercraft. This sports board mount also includes two laterally spaced-apart clamping members configured to be selectively moved relative to the body amongst a range of positions to operatively engage and retain the sports board relative to the body. This sports board mount further includes an actuator that is operatively coupled to the two laterally spaced-apart clamping members and configured to selectively move the clamping members amongst their respective ranges of positions.

In another embodiment, the sports board mount includes a body. The body includes a base, a first upper arm, a first lower arm, a second upper arm, and a second lower arm. The base is configured to be operatively coupled to a structure. The first upper arm extends from the base. The first lower arm extends from the base and is spaced below the first upper arm to permit receipt of a first sports board between the first upper arm and the first lower arm. The second upper arm extends from the base and is spaced laterally from the first upper arm. The second lower arm extends from the base and is spaced below the second upper arm and laterally from the first lower arm. The second lower arm is located to permit receipt of the first sports board between the second upper arm and the second lower arm. This sports board mount further includes a first clamping member, a second clamping member, and an upper actuator.

The first clamping member is operatively coupled to selectively extend from one of the first upper arm and the first lower arm. The first clamping member also is configured to be selectively moved between a first-clamping-member retracted position and a first-clamping-member range of engagement positions for engagement with and securement of the first sports board between the first upper arm and the first lower arm.

The second clamping member is operatively coupled to selectively extend from one of the second upper arm and the second lower arm. The second clamping member also is configured to be selectively moved between a second-clamping-member retracted position and a second-clamping-member range of engagement positions for engagement with and securement of the first sports board between the second upper arm and the second lower arm.

The upper actuator is operatively coupled to the first clamping member and to the second clamping member. The upper actuator is configured to selectively move the first clamping member and the second clamping member responsive to an input from a user.

The methods include positioning the sports board in a first board receipt region of the sports board mount and in a second board receipt region of the sports board mount. The first board receipt region is defined between a first upper arm of the sports board mount and a first lower arm of the sports board mount. The second board receipt region is defined between a second upper arm of the sports board mount and a second lower arm of the sports board mount. The methods further include operating an actuator to operatively retain the sports board within the first sports board receipt region with a first clamping member of the sports board mount and also to operatively retain the sports board within the second board receipt region with a second clamping member of the sports board mount.

### BRIEF DESCRIPTION OF THE DRAWINGS

FIG. 1 is a schematic diagram representing sports board mounts according to the present disclosure.

FIG. 2 is an isometric view of an example sports board mount according to the present disclosure, together with an example sports board secured in a lower board receipt region thereof.

FIG. 3 is a front view of the sports board mount of FIG. 2.

FIG. 4 is a rear view of the sports board mount of FIG. 2.

FIG. 5 is a left side view of the sports board mount of FIG. 2 with a left side cover removed.

FIG. 6 is a right side view of the sports board mount of FIG. 2 with a right side cover removed.

FIG. 7 is a top view of the sports board mount of FIG. 2.

FIG. 8 is a bottom view of the sports board mount of FIG. 2.

FIG. 9 is a fragmentary exploded view of a portion of the sports board mount of FIG. 2 illustrating the upper clamping mechanism.

FIG. 10 is a fragmentary exploded view of a portion of the sports board mount of FIG. 2 illustrating the lower clamping mechanism.

FIG. 11 is a left side view of the sports board mount of FIG. 2 with a left side cover removed and illustrating a first clamping member in a fully retracted position and a first bottom clamping member in a fully extended position.

FIG. 12 is a left side view of the sports board mount of FIG. 2 with a left side cover removed and illustrating a first clamping member and a first bottom clamping member in respective intermediate positions.

FIG. 13 is a left side view of the sports board mount of FIG. 2 with a left side cover removed and illustrating a first clamping member in a fully extended position and a first bottom clamping member in a fully retracted position.

FIG. 14 is a flowchart depicting methods, according to the present disclosure, of retaining a sports board within a sports board mount.

FIG. 15 is a flowchart depicting methods, according to the present disclosure, of retaining a sports board within a sports board mount.

### DESCRIPTION

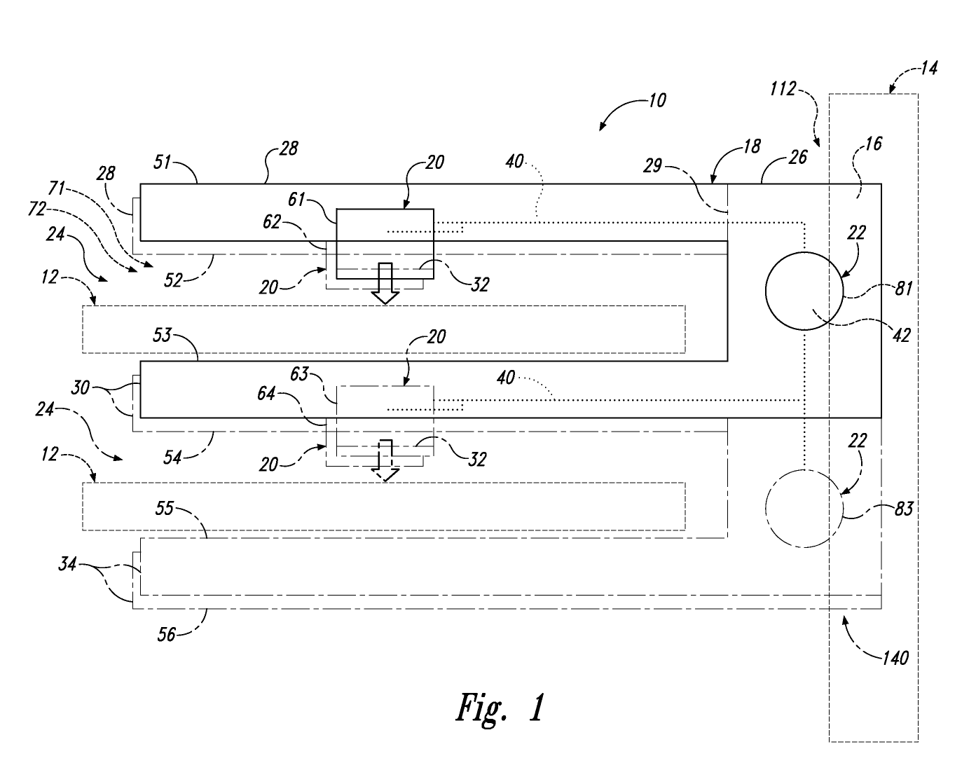

FIGS. 1-15 provide examples of sports board mounts 10, according to the present disclosure, of structures 14 that include, utilize, and/or may be operatively attached to sports board mounts 10, and/or of methods 200/300, according to the present disclosure, of retaining a sports board within a sports board mount. Elements that serve a similar, or at least substantially similar, purpose are labeled with like numbers in each of FIGS. 1-15, and these elements may not be discussed in detail herein with reference to each of FIGS. 1-15. Similarly, all elements may not be labeled in each of FIGS. 1-15, but reference numerals associated therewith may be utilized herein for consistency. Elements, components, and/or features that are discussed herein with reference to one or more of FIGS. 1-15 may be included in and/or utilized with any of FIGS. 1-15 without departing from the scope of the present disclosure.

In general, elements that are likely to be included in a given (i.e., a particular) embodiment are illustrated in solid lines, while elements that are optional to a given embodiment are illustrated in dashed lines. However, elements that are shown in solid lines are not essential to all embodiments, and an element shown in solid lines may be omitted from a given embodiment without departing from the scope of the present disclosure.

FIG. 1 is a schematic diagram representing sports board mounts 10 according to the present disclosure. Sports board mounts 10 are apparatuses that are configured to operatively receive and retain one or more sports boards 12 for transportation and/or storage. Sports board mounts 10 may be operatively coupled to a structure 14 and/or may operatively couple one or more sports boards 12 to structure 14. Examples of structure 14 include, but are not limited to, any suitable boat, tower, vehicle, nonstationary vehicle, stand, pillar, wall, watercraft, vessel, ship, automobile, off road vehicle, recreational vehicle, aircraft, and/or any other suitable structure associated with desired positioning of one or more sports boards 12. Examples of sports boards 12 that may be retained by sports board mounts 10 include, but are not limited to, wake boards, wake surf boards, surf boards, wind surfing boards, water skis, snow skis, snowboards, stand-up paddle boards, skateboards, and/or any other suitable sports board that may be operatively retained by sports board mounts 10.

Sports board mounts 10 additionally or alternatively may be configured to receive and retain other sports equipment, such as kayaks and/or canoes. Additionally or alternatively, sports board mounts 10 may be configured to receive and retain, and/or may be utilized for holding, any suitable structure that is sized and/or shaped appropriately. Accordingly, sports board mounts 10 additionally or alternatively may be described and/or referred to herein as mounts 10, retainers 10, racks 10, storage devices 10, and/or supports 10, and sports boards 12 additionally or alternatively, when appropriate, may be described simply as devices 12 and/or members 12, such as to be retained by mounts 10.

In FIG. 1, sports board mounts 10 are illustrated in an overlapping relationship with a generic structure 14, schematically representing that sports board mount 10 may include any suitable mounting and/or coupling structure 16 for operative attachment to structure 14. In some embodiments, coupling structure 16 may be specifically configured for mating with a particular structure 14, such as, for example, a wake board boat tower having a specific size and/or shape. However, it also is within the scope of the present disclosure that coupling structure 16 be configured to operatively attach to various structures 14 without limitation to a particular size, shape, and/or configuration of structure 14. Examples of coupling structure 16 include one or more of a clamp, a fastener, a bracket, etc.

As schematically illustrated in solid lines in FIG. 1, mount 10 includes a body 18. Body 18 may include a base 26 that may be operatively coupled to, or configured to be operatively coupled to, structure 14, such as via mounting structure 16. In addition, body 18 also may be configured (e.g., sized and/or shaped) to receive at least one sports board 12, such as within a board receipt region 24 that may be at least partially, or even completely, defined by body 18. Body 18 may include and/or be formed from any suitable material. As examples, body 18 may include and/or be formed from a rigid material or an at least substantially rigid material. As more specific examples, body 18 may include and/or be formed from a metal, a steel, stainless steel, aluminum, a metal alloy, a polymeric material, a plastic, a nylon, and/or a composite material.

Mount 10 also includes a clamping member 20. Clamping member 20 may be configured to be selectively moved relative to the body amongst a range of positions to operatively engage and retain sports board 12 relative to the body. Clamping member 20 also may include and/or be formed from any suitable material, including those materials that are discussed herein with reference to body 18.

Mount 10 further includes an actuator 22. Actuator 22 may be operatively coupled to the clamping member and may be configured to selectively move the clamping member amongst its range of positions. As discussed in more detail herein, and as schematically and optionally illustrated in FIG. 1 in dash-dot lines, some mounts 10 may include more than one clamping member 20 and/or more than one actuator 22. Furthermore, some actuators 22 may be configured to move more than one clamping member 20, such as a pair of laterally spaced clamping members 20, responsive to a single user input to the actuator.

The body 18 of mount 10 may be described as defining at least one, and optionally more than one, board receipt region 24. Board receipt region(s) 24 may be sized and/or shaped to selectively receive and, in conjunction with one or more respective clamping members 20, retain sports board 12 (or other device 12 or member 12) at least partially within board receipt region 24. Body 18 may take any suitable form to accomplish these functions. For example, as schematically illustrated in FIG. 1, the body of mount 10 typically will include base 26, which also may be referred to herein as a base region 26. In addition, body 18 may include and/or define one or more upper arms 28 that may extend from the base region, and one or more lower arms 30 that also may extend from the base region. Lower arms 30 may be spaced below upper arms 28. In some embodiments, although not required, the spacing between the upper arms and the lower arms may be adjustable, for example, to facilitate receipt of different thicknesses of boards 12 within the board receipt region. Board receipt region 24 additionally or alternatively may be referred to as a board receiver 24, as a board mount 24, as a board mounting region 24, and/or as a receptacle 24 that may be configured to selectively receive and retain any suitable structure and/or device, such as sports board 12.

As schematically and optionally illustrated in FIG. 1 in dash-dot lines, body 18 of mount 10 may include two laterally spaced upper arms 28 and/or two laterally spaced lower arms 30. Stated differently, body 18 may include a left, or first, upper arm 51 and a right, or second, upper arm 52. Body 18 also may include a left, or first, lower arm 53 and a right, or second, lower arm 54, with the first upper arm being spaced above the first lower arm and with the second upper arm being spaced above the second lower arm. Such a configuration may be suited to receive, support, and/or retain an elongate sports board 12, for example. In some embodiments, although not required, the lateral spacing of the first and second arms may be adjustable, for example, to facilitate support of different lengths of sports boards 12 within board receipt region 24. However, it also is within the scope of the present disclosure that body 18 may include only a single upper arm 28 and/or only a single lower arm 30.

Arms 28/30 according to the present disclosure additionally or alternatively may be described as extensions 28/30, support members 28/30, and/or elongate members 28/30. As used herein, relative terms, such as upper, lower, first, second, left, and/or right are not limiting, in so far as a mount 10 may be operatively coupled to a structure 14 in any suitable and desired relative orientation, and thus the perspective of an observer may change, while the relative positioning of the upper, lower, first, second, left, and/or right components may remain the same.

Although typically including one or more upper arms 28, it is within the scope of the present disclosure that a mount 10 may not include any upper arms 28, as schematically represented by the dash-dot line in FIG. 1 at 29. In such embodiments, clamping member 20 may define the upper side of the board receipt region 24.

Clamping member 20 may be associated with and/or operatively coupled to selectively extend from upper arm 28 and/or from lower arm 30. In FIG. 1, clamping member 20 is illustrated in solid lines as being associated with upper arm 28, which configuration may be desirable, although not required, for stability of a sports board 12 while the clamping member is being moved to engage the sports board and/or to retain the sports board in board receipt region 24.

Clamping member 20 may be described as including at least a retracted position, in which the clamping member is positioned to permit operative insertion of sports board 12 into a corresponding board receipt region 24. Clamping member 20 additionally may be described as including a range of engagement positions relative to the retracted position. This range of engagement positions may facilitate securement of sports boards of various sizes or thicknesses within a respective board receipt region 24 of mount 10 and/or may facilitate engagement and securement of sports board 12 by the clamping member.

Clamping members 20 may take any suitable form such that they are configured to operatively move relative to body 18 of mount 10 and thus to operatively engage and secure sports board 12 within board receipt region 24. In some embodiments, the clamping member may be pivotally coupled relative to the body. Additionally or alternatively, in some embodiments, the clamping member may be linearly and/or translationally coupled relative to the body. In some embodiments, although not required, the extent of the engagement positions of the clamping member may be adjustable, such as to optionally set a maximum translation of the clamping member and thus to prevent or restrict over-clamping and possibly damaging sports board 12 that may be received within board receipt region 24.

As schematically and optionally illustrated in dash-dot lines in FIG. 1, sports board mount 10 may include two laterally spaced clamping members 20. Stated another way, sports board mount 10 may include a left, or first, clamping member 61 and a right, or second, clamping member 62. First clamping member 61 may be associated with and/or may extend from first upper arm 51 and/or first lower arm 53. Similarly, second clamping member 62 may be associated with and/or may extend from second upper arm 52 and/or second lower arm 54.

First clamping member 61 may be configured to be selectively moved between a first-clamping-member retracted position and a first-clamping-member range of engagement positions. Similarly, second clamping member 62, when present, may be configured to be selectively moved between a second-clamping-member retracted position and a second-clamping-member range of engagement positions. This may permit and/or facilitate engagement of second clamping member 62 with a respective portion of sports board 12 and/or securement of sports board 12 within a corresponding sports board receipt region 24 that may be defined between the first upper arm and the first lower arm and also between the second upper arm and the second lower arm.

As illustrated in dash-dot lines in FIG. 1, clamping members 20 may include a conforming portion 32 that may be configured to at least partially conform to a surface of sports board 12 when the sports board is received and secured within board receipt region 24, such as when the respective clamping member is translated toward and into engagement with the sports board. Conforming portion 32, when present, may take any suitable form and/or configuration. As examples, the conforming portion may include a resilient material that is configured to grip the sports board and/or become reversibly compressed when the clamping member is translated toward and into engagement with the sports board. Additionally or alternatively, the conforming portion may include a pivotal foot that may be configured to automatically orient relative to the surface of the sports board that is engaged thereby. Other configurations of conforming portions also are within the scope of the present disclosure.

As illustrated in dotted lines in FIG. 1, actuator 22 is linked to clamping member(s) 20, and the dotted lines in FIG. 1 schematically represent any suitable connection 40 between the actuator and the clamping member. Connection 40 also may be referred to herein as an operational linkage 40 and/or as a coupling 40 between the actuator and a clamping member. Connection 40 may be utilized such that the actuator is configured to selectively translate the clamping member to and from its retracted position and amongst its engagement positions. As examples, connection 40 may include one or more of a mechanical linkage, a hydraulic linkage, and/or a pneumatic linkage. Additionally or alternatively, an actuator and/or a coupling between an actuator and a clamping member may be electrically controlled. Clamping members 20, actuators 22, and/or couplings 40 may form a portion of an upper clamping mechanism 112 and/or a lower clamping mechanism 140, which are discussed in more detail herein.

Examples of actuators 22 include knobs configured to be selectively grasped and rotated, lever arms configured to be selectively grasped and pivoted, and/or push-buttons configured to be selectively engaged, pushed, and/or released. Actuator 22 may be remote from body 18 of mount 10, and thus the mount may be described as being remote controlled for operation of the clamping member(s). In the example of a remote electric actuator, the actuator may be wired to a mechanism associated with the clamping member or the actuator may communicate wirelessly with a mechanism associated with the clamping member. As an example, an actuator may be positioned on a dash and/or in a cockpit region of a boat so as to be accessible to an operator of the boat. In some embodiments, the actuator, or actuators, 22 may be positioned on a lateral side, or on both laterals sides, of the body 18 of the mount, such as on the left and/or right side of the body.

In embodiments that include more than one upper arm 28 and/or more than one lower arm 30, clamping member 20 may be associated with two laterally spaced arms, such as schematically illustrated in FIG. 1 in dotted lines, where clamping member 20 is associated with two laterally spaced upper arms 28. Under these conditions, first upper arm 51 and first lower arm 53 may be referred to herein as defining a first board receipt region 71 for receipt of sports board 12. Similarly, second upper arm 52 and second lower arm 54 may be referred to herein as defining a second board receipt region 72 for receipt of sports board 12.

In some such embodiments, a single actuator 22 may be configured to operate both first clamping member 61 and second clamping member 62, with this optional configuration schematically illustrated in FIG. 1 via connection 40 between actuator 22 schematically including a branch relative to the optionally illustrated upper clamping member 20 (i.e., second clamping member 62). In such embodiments, actuator 22, which also may be referred to herein as an upper actuator 81, may be referred to as being operatively coupled to both first clamping member 61 and second clamping member 62. Additionally or alternatively, the upper actuator may be referred to herein as being configured to selectively move both the first clamping member and the second clamping member responsive to a user input to, or user actuation of, the actuator. This may include selectively moving the first clamping member from the first-clamping-member retracted position and amongst the first-clamping-member range of engagement positions, moving the second clamping member from the second-clamping-member retracted position and amongst the second-clamping-member range of engagement positions, and/or concurrently moving the first clamping member and the second clamping member.

In embodiments in which the actuator 22 is positioned on a lateral side of the body 18, such a configuration for upper actuator 81 may permit two clamping members 20 to be operated and/or actuated by a user, for example, without having to reach around to both lateral sides of the mount's body to operate both clamping members. Depending on the particular application and installation of such a mount 10, this configuration may be beneficial, such as when it is difficult for a user to reach both sides of the body of a mount. As an example, some configurations of wake board boat towers, to which a mount 10 may be operatively coupled, present a challenge for a user to reach both sides of the mount. Accordingly, having a single actuator 22 on a lateral side of body 18 of mount 10 that actuates both the first clamping member and the second clamping member may facilitate ease of operation when stowing and/or removing a sports board 12 from the board receipt region of the mount. Additionally or alternatively, a respective actuator 22 (i.e., a first actuator and a second actuator) may be associated with each lateral side of body 18 and may be configured such that the first clamping member and the second clamping member both are actuated and/or moved amongst their respective range of positions responsive to a user input to only one of the actuators (i.e., to the first actuator or to the second actuator).

Clamping members 20 may include and/or be designed to exhibit a compliance that may be adapted, configured, designed, and/or selected to facilitate securement of sports boards 12 with different and/or varying thicknesses along a length thereof and/or at regions of contact with respective clamping members 20. As an example, sports board mount 10 may include first clamping member 61 and second clamping member 62. The first clamping member and the second clamping member together may be utilized to secure sports board 12 within a respective board receipt region 24 despite variations in the thickness of the sports board. As a more specific example, both the first clamping member and the second clamping member may be configured to engage and secure the sports board within the respective board receipt region regardless of the thickness (or thickness variation) of the sports board.

For example, the first clamping member may include and/or exhibit a first compliance and/or the second clamping member may include and/or exhibit a second compliance. The first compliance and/or the second compliance may be adapted, configured, and/or selected to facilitate securement and/or retention of sports boards that may have a different thickness at regions of contact with the first clamping member and with the second clamping member.

The first compliance and the second compliance may be generated, produced, and/or exhibited in any suitable manner. As an example, the first compliance may be defined by, or may be a result of, a material of construction of the first clamping member. Similarly, the second compliance may be defined by, or may be a result of, a material of construction of the second clamping member. Under these conditions, the material of construction of the first clamping member and/or the material of construction of the second clamping member may include and/or be a compliant material. Examples of the compliant material include a resilient material, a deformable material, a compliant spring, a compliant spring steel, a compliant metal, a compliant metal alloy, a compliant aluminum, a compliant polymer, and/or a compliant nylon.

As another example, the first compliance may be defined by, or may be a result of, a shape of the first clamping member. Similarly, the second compliance may be defined by, or may be a result of, a shape of the second clamping member. Under these conditions, the first clamping member and/or the second clamping member may be shaped to be flexible, to be resilient, and/or to deform upon operative engagement with the sports board.

As yet another example, an operational linkage 42 may extend between and/or may at least partially operatively interconnect the upper actuator, the first clamping member, and the second clamping member. Under these conditions, the operational linkage may be configured to move responsive to motion of the upper actuator, may be configured to provide compliance between the first clamping member and the second clamping member, may be configured to generate the first compliance, and/or may be configured to generate the second compliance. Examples of the operational linkage include a spring and/or a torsion spring. Such an operational linkage may be configured to permit limited rotational motion of the first clamping member relative to the second clamping member.

As schematically and optionally illustrated in dash-dot lines in FIG. 1, some embodiments of mounts 10 may be configured to receive and retain more than one sports board 12. For example, body 18 may define two or more board receipt regions 24 that are spaced apart vertically relative to each other. In some such embodiments, body 18 may include and/or define one or more bottom arms 34 that include at least a first bottom arm 55 that may extend from the base region 26, with the first bottom arm being spaced vertically below first lower arm 53. Additionally, such embodiments may include at least a first bottom clamping member 63 that may be operatively coupled to selectively extend from either first lower arm 53 or first bottom arm 55. In FIG. 1, the optional bottom clamping members 20 are illustrated as being associated with lower arms 30, but it is within the scope of the present disclosure that a clamping member 20 may be associated with bottom arms 34. In embodiments that include bottom arms 34, lower arms 30 additionally or alternatively may be described as middle arms 30.

In embodiments of mounts 10 that include more than one board receipt region 24 and thus that include the first clamping member 61 and the first bottom clamping member 63, a single actuator 22, such as upper actuator 81, may be configured to operate both of the clamping members, as schematically and optionally illustrated in FIG. 1 with dotted connection 40 extending from upper actuator 81 to first bottom clamping member 63. Under these conditions, the first clamping member may have the first compliance and/or the first bottom clamping member may have a first bottom clamping member compliance. The first compliance and/or the first bottom clamping member compliance may be configured to facilitate securement of two sports boards having different thicknesses at regions of contact with the first clamping member and with the first bottom clamping member. Similar to the first clamping member, the first bottom clamping member compliance may be defined by a shape and/or material of construction of the first bottom clamping member.

Alternatively, such a mount 10 may include a bottom actuator 83 that is configured to operate first bottom clamping member 63, as also optionally and schematically illustrated in FIG. 1. Examples of bottom actuator 83 are discussed herein with reference to upper actuator 81. In such embodiments, the two actuators may be positioned on the same lateral side of the mount's body, so that access to both actuators by a user is facilitated. Regardless of the exact configuration, a respective actuator 22 may be configured to selectively move first bottom clamping member 63 between a bottom-clamping-member retracted position and a bottom-clamping-member range of engagement positions for engagement and securement of the second sports board that may be positioned between lower arm 30 and bottom arm 34.

As illustrated in dash-dot lines in FIG. 1, mount 10 may include a plurality of bottom arms 34, including at least first bottom arm 55 and a second bottom arm 56. The second bottom arm may be laterally spaced from the first bottom arm and/or may be spaced below the second lower arm. Thus, mount 10 may be configured to receive a second sports board 12 between the first lower arm and the first bottom arm and also between the second lower arm and the second bottom arm. As further illustrated in dash-dot lines in FIG. 1, mount 10 also may include a second bottom clamping member 64. The second bottom clamping member may be operatively coupled to selectively extend from one of the second lower arm and the second bottom arm. The second bottom clamping member may be configured to be selectively moved between a second-bottom-clamping-member retracted position and a second-bottom-clamping-member range of engagement positions for engagement and securement of the second sports board between the second lower arm and the second bottom arm, such as via operation of a respective actuator 22.

It is within the scope of the present disclosure that upper actuator 81 (illustrated in solid lines in FIG. 1) may be operatively coupled to and/or may be configured to actuate the first clamping member, the second clamping member, the first bottom clamping member, and the second bottom clamping member. Alternatively, bottom actuator 83 (illustrated in dash-dot lines in FIG. 1) may be operatively coupled to the first bottom clamping member and the second bottom clamping member and may be configured to actuate the first bottom clamping member and the second bottom clamping member independent from actuation of the first clamping member and the second clamping member. Regardless of the exact configuration, the first bottom clamping member may include and/or have a first bottom clamping member compliance, and the second bottom clamping member may include and/or have a second bottom clamping member compliance. The first bottom clamping member compliance and/or the second bottom clamping member compliance may be configured to facilitate securement of sports boards having different thicknesses at regions of contact with the first bottom clamping member and with the second bottom clamping member. Similar to the first clamping member, the second bottom clamping member compliance may be defined by a shape and/or material of construction of the first bottom clamping member.

Mounts 10 additionally and optionally may include pads, coatings, covers, or other resilient members that are operatively coupled to one or more of the body 18 and the clamping member(s) 20, for example to prevent damage to a sports board and/or to facilitate a resilient engagement for securement of a sports board within a board receipt region. As examples, such optional resilient members may be constructed of a closed-cell foam or of an open-cell foam.

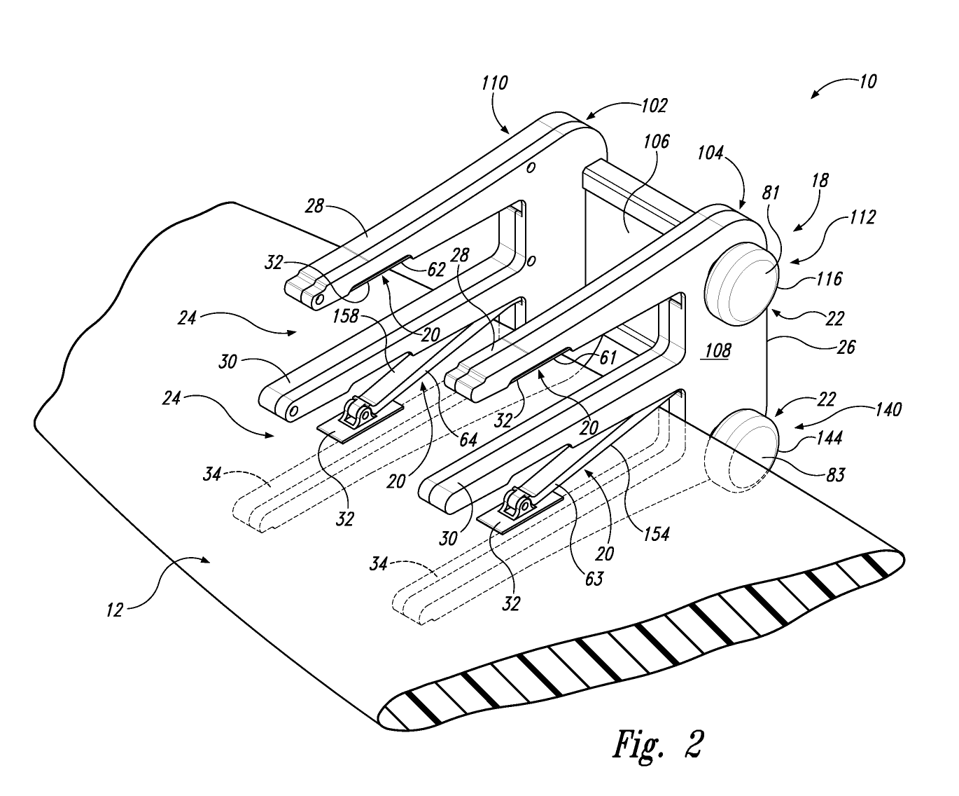

FIGS. 2-13 provide more specific examples of sports board mounts 10 according to the present disclosure, components of mounts 10, configurations of mounts 10, features of mounts 10, and/or operation of mounts 10. Mounts 10 of FIGS. 2-13 may include and/or be more detailed representations of mounts 10 of FIG. 1, and any of the components, configurations, structures, and/or features that are discussed herein with reference to any of FIGS. 2-13 may be included in and/or utilized with mounts 10 of FIG. 1 without departing from the scope of the present disclosure. Similarly, any of the components, configurations, structures, and/or features that are discussed herein with reference to mounts 10 of FIG. 1 may be included in and/or utilized with mounts 10 of FIGS. 2-13 without departing from the scope of the present disclosure.

With reference to FIG. 2, mount 10 includes two board receipt regions 24, which may be described as upper and lower board receipt regions 24. Mount 10 also includes a body 18 that includes a base region 26, two laterally spaced-apart upper arms 28 extending from the base region, two laterally spaced-apart middle arms 30 extending from the base region, and two laterally spaced-apart bottom arms 34 extending from the base region. Mount 10 further includes two clamping members 20 (i.e., a first clamping member 61 and a second clamping member 62) associated with the upper arms and two clamping members 20 (i.e., a first bottom clamping member 63 and a second bottom clamping member 64) associated with the middle arms. Each clamping member 20 of mount 10 includes a conforming portion 32 that includes a pivotal foot for conformance to the surface of a sports board 12 received within the respective board receipt region.

Mount 10 also includes a single actuator 22 (i.e., an upper actuator 81) for operation of both the left and right upper clamping members, and a single actuator 22 (i.e., a bottom actuator 83) for operation of both of the left and right bottom clamping members, with the two actuators both being located on a single lateral side of the mount's body. Accordingly, with operation of only a single actuator, a user may selectively position a respective pair of clamping arms for receipt and securement of a sports board, or other structure, within a respective board receipt region. Mount 10 may be particularly well-suited for installation on one of a right or left tower of a wake board boat. A similarly configured mount 10, generally constructed in the mirror image of mount 10 also may be provided, for example, for installation on the other of the right or left tower of a wake board boat. For example, the location of the actuators 22 may be more readily accessed by a user depending on which side of the boat the mount is installed.

The body 18 of mount 10 includes a right portion 102, a left portion 104, and a rear portion 106 that interconnects the left and right portions. A left cover plate 108 and a right cover plate 110 are included to facilitate assembly of the mount 10 and to provide access to the mechanisms associated with the actuators and clamping members.

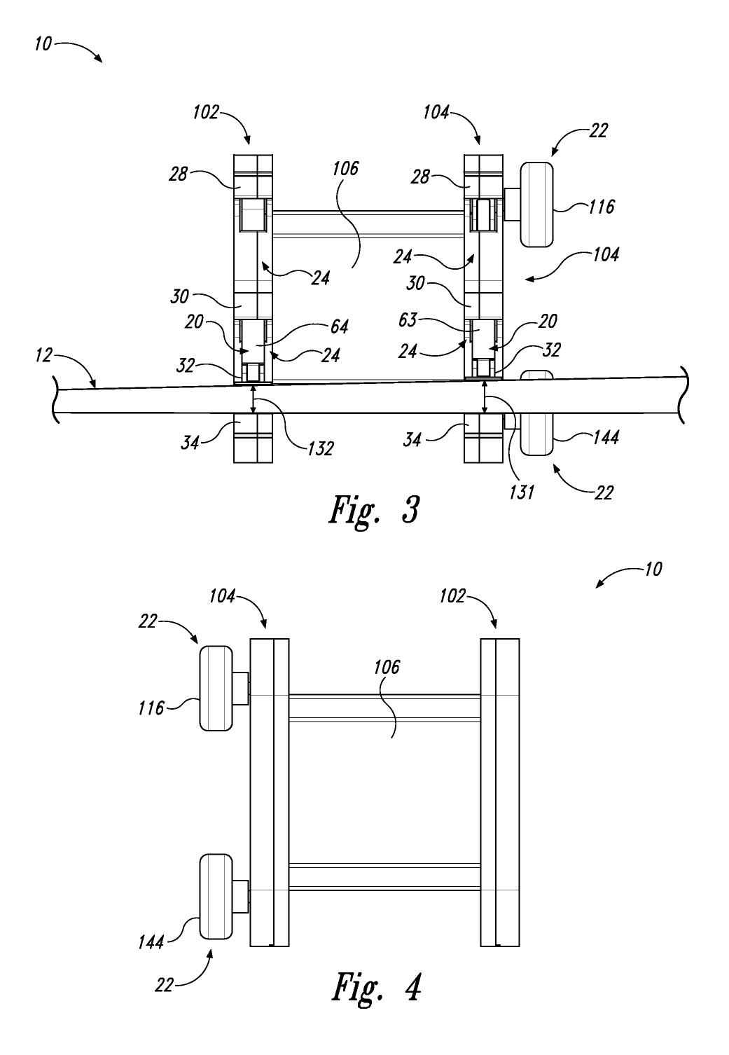

FIG. 2 is an isometric view of an example sports board mount 10 according to the present disclosure, together with an example sports board 12 secured in a lower board receipt region 24 thereof, while FIG. 3 is a front view of the sports board mount of FIG. 2. As perhaps illustrated most clearly in FIG. 2, a lower left lever arm 154 may define at least a portion of lower left clamping member 20, while a lower right lever arm 158 may define at least a portion of a lower right clamping member 20.

As perhaps illustrated most clearly in FIG. 3 and discussed herein, clamping members 20 according to the present disclosure may be configured to operatively retain sports boards 12 that vary in thickness across a length thereof. As illustrated, board 12 may define a first thickness 131 at a point of contact with a first bottom clamping member 63 and a second thickness 132 at a point of contact with a second bottom clamping member 64. The clamping members may include a respective compliance (such as the first lower compliance and the second lower compliance, which are discussed in more detail herein) that may permit contact with sports board 12 of a range of first thicknesses 131, second thicknesses 132, and/or ratios of the first thickness to the second thickness. As examples, clamping members 20 of mounts 10 may be configured to contact sports boards 12 when the ratio of the first thickness to the second thickness is at least 0.1, at least 0.2, at least 0.3, at least 0.4, at least 0.5, at least 0.6, or at least 0.7. Additionally or alternatively, clamping members 20 of mounts 10 also may be configured to contact sports boards 12 when the ratio of the first thickness to the second thickness is less than 1.0, less than 0.9, less than 0.8, less than 0.7, less than 0.6, less than 0.5, less than 0.4, or less than 0.3.

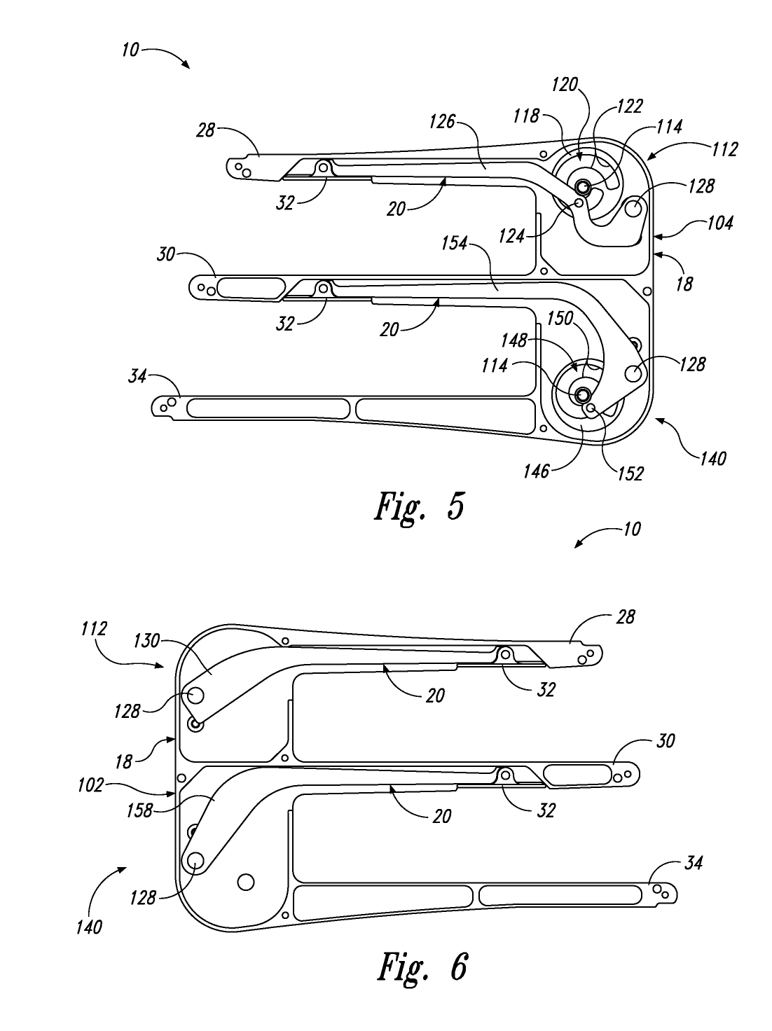

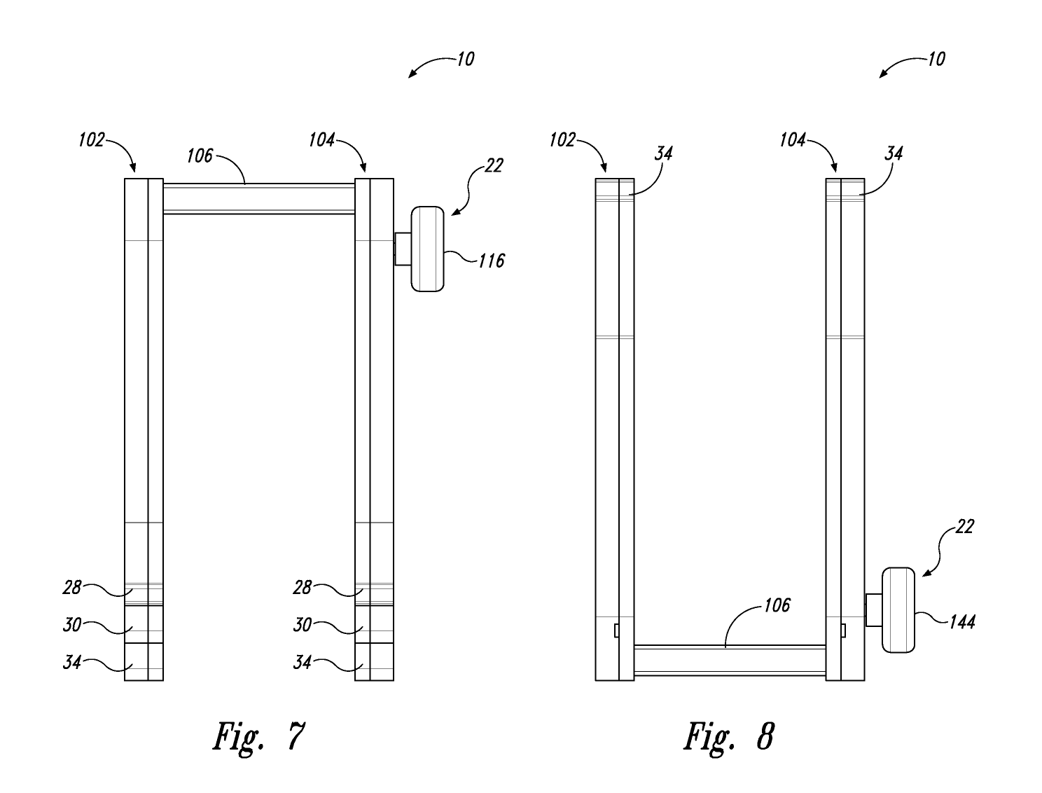

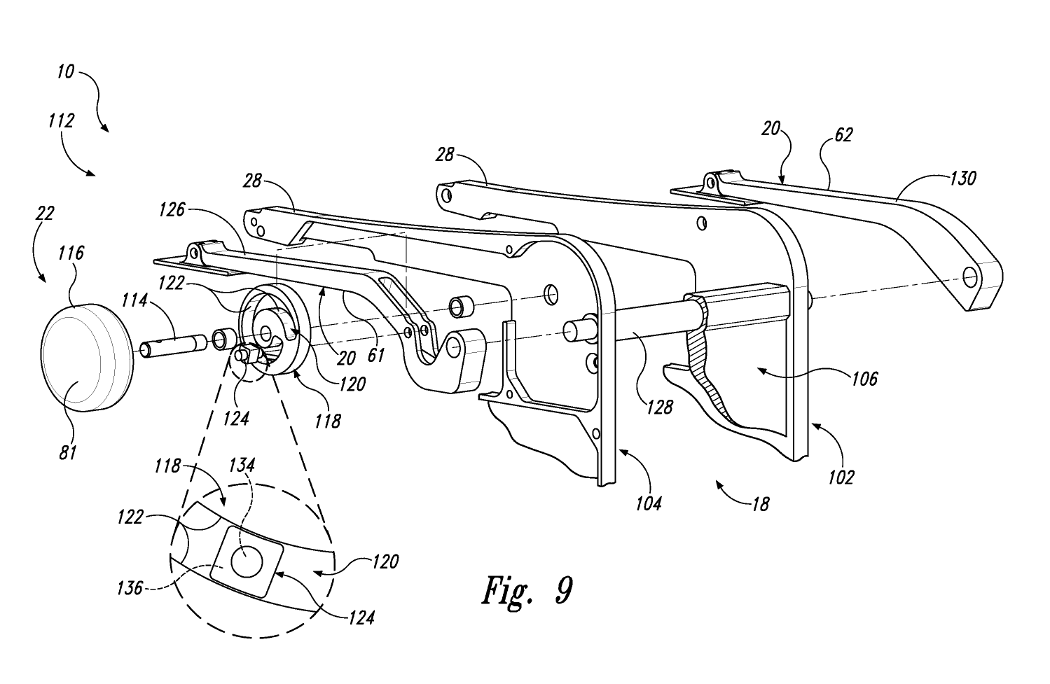

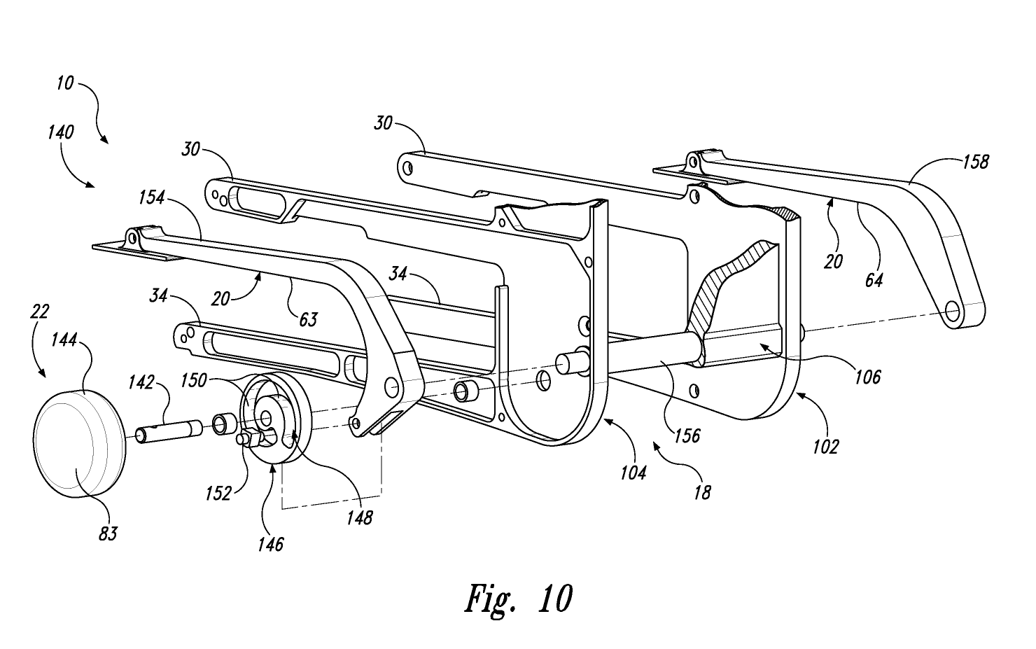

FIG. 4 is a rear view of the sports board mount of FIG. 2, while FIG. 5 is a left side view of the sports board mount of FIG. 2 with left cover plate 108 (as illustrated in FIG. 2) removed; and FIG. 6 is a right side view of the sports board mount of FIG. 2 with right cover plate 110 removed. FIG. 7 is a top view of the sports board mount of FIG. 2, and FIG. 8 is a bottom view of the sports board mount of FIG. 2. FIG. 9 is a fragmentary exploded view of a portion of the sports board mount of FIG. 2 illustrating an upper clamping mechanism 112, while FIG. 10 is a fragmentary exploded view of a portion of the sports board mount of FIG. 2 illustrating a lower clamping mechanism 140.

As illustrated collectively by FIGS. 2-9, upper clamping mechanism 112 may include at least first clamping member 61, second clamping member 62, and upper actuator 81. In addition, upper clamping mechanism 112 also may include an upper shaft 114 that extends through left cover plate 108, is rotatable relative to body 18, and to which upper actuator 81, in the form of an upper knob 116, is operatively coupled outside of the left cover plate (upper knob 116 is shown in FIGS. 2-4, 7, and 9). Upper shaft 114 is rigidly connected to an upper cam member 118 that includes a spiral-shaped cam channel 120 with opposing cam surfaces 122.

An upper follower 124 is positioned within the cam channel, is engaged with the opposing cam surfaces, and includes outer surfaces shaped to correspond to the concave and convex contours of opposing cam surfaces 122. This is illustrated most clearly in the inset of FIG. 9, which is an end view of upper follower 124. As illustrated therein, upper follower 124 may include a follower bushing 136 that rides on a follower shaft 134. Under these conditions, follower bushing 136 may be configured to pivot on follower shaft 134. Additionally or alternatively, follower bushing 136 and follower shaft 134 may be a monolithic and/or a unitary structure. Under these conditions, follower bushing 136 and follower shaft 134 may be configured to pivot within cam channel 120 as a unit. Follower bushing 136 may be shaped to correspond to the concave and convex contours of opposing cam surfaces 122, as discussed.

Upper follower 124 is pivotally connected to an upper left lever arm 126 that defines first clamping member 61. The upper left lever arm is rigidly connected to an upper axle 128 that extends through rear portion 106 of body 18, and which in turn is rigidly connected to an upper right lever arm 130 that defines second clamping member 62, as seen in FIG. 9. The upper axle defines an upper pivotal axis of the first clamping member and of the second clamping member.

Accordingly, as illustrated in connection with FIGS. 5 and 9, when a user selectively rotates upper knob 116 (shown in FIG. 9) in a counterclockwise, or first, direction, upper shaft 114 also rotates counterclockwise, which in turn also rotates the upper cam member 118 counterclockwise. This causes upper follower 124 to travel in a clockwise direction in spiral-shaped cam channel 120 and/or away from upper shaft 114 in a first radial direction. This in turn causes upper left lever arm 126 and upper right lever arm 130 (shown in FIG. 9) to pivot in a counterclockwise, or first, pivotal direction away from their retracted positions. When a user selectively rotates the upper knob in a clockwise, or second, direction, the upper shaft also rotates clockwise, which in turn also rotates the upper cam member clockwise, which causes the upper follower to travel in a counterclockwise direction in the spiral-shaped cam channel and/or toward upper shaft 114 in a second radial direction. This in turn causes the upper left lever arm and the upper right lever arm to pivot in a clockwise, or second, pivotal direction toward their retracted positions.

While mount 10 is configured so that the clamping members translate away from their retracted positions in response to a counterclockwise rotation of the actuators and toward their retracted positions in response to a clockwise rotation of the actuators, a mount 10 may be configured with the opposite result. Such an opposed configuration, although not required, may be well suited for installation on an opposite side of a boat, for example.

Similarly, and as illustrated collectively by FIGS. 2-8 and 10, lower clamping mechanism 140 may include at least first bottom clamping member 63, second bottom clamping member 64, and bottom actuator 83. More specifically, lower clamping mechanism 140 includes a lower shaft 142 that extends through left cover plate 108, is rotatable relative to body 18, and to which bottom actuator 83, in the form of a lower knob 144, is operatively coupled outside of the left cover plate (lower knob 144 is shown in FIGS. 2-4, 8, and 10). Lower shaft 142 is rigidly connected to a lower cam member 146 that includes a spiral-shaped cam channel 148 with opposing cam surfaces 150.

A lower follower 152 is positioned within the lower cam channel, is engaged with the opposing cam surfaces, and includes outer surfaces shaped to correspond to the concave and convex contours of the opposing cam surfaces 150 (as illustrated in FIG. 9 with reference to upper follower 124). The lower follower is pivotally connected to a lower left lever arm 154 that defines first bottom clamping member 63. The lower left lever arm is rigidly connected to a lower axle 156 that extends through rear portion 106 of the mount's body, and which in turn is rigidly connected to a lower right lever arm 158 that defines second bottom clamping member 64, as seen in FIG. 10.

Accordingly, as understood from FIGS. 6 and 10, when a user selectively rotates lower knob 144 in a counterclockwise, or first, direction, lower shaft 142 also rotates counterclockwise, which in turn also rotates lower cam member 146 counterclockwise. This causes lower follower 152 to travel in a clockwise direction in spiral-shaped cam channel 148 and/or away from lower shaft 142 in a first radial direction. This in turn causes lower left lever arm 154 and lower right lever arm 158 to pivot in a counterclockwise, or first, pivotal direction away from their retracted positions. When a user selectively rotates the lower knob in a clockwise, or second, direction, the lower shaft also rotates clockwise, which in turn also rotates the lower cam member clockwise, which causes the lower follower to travel in a counterclockwise direction in the spiral-shaped cam channel and/or toward lower shaft 142 in a second radial direction. This in turn causes the lower left lever arm and the lower right lever arm to pivot in a clockwise, or second, direction toward their retracted positions.

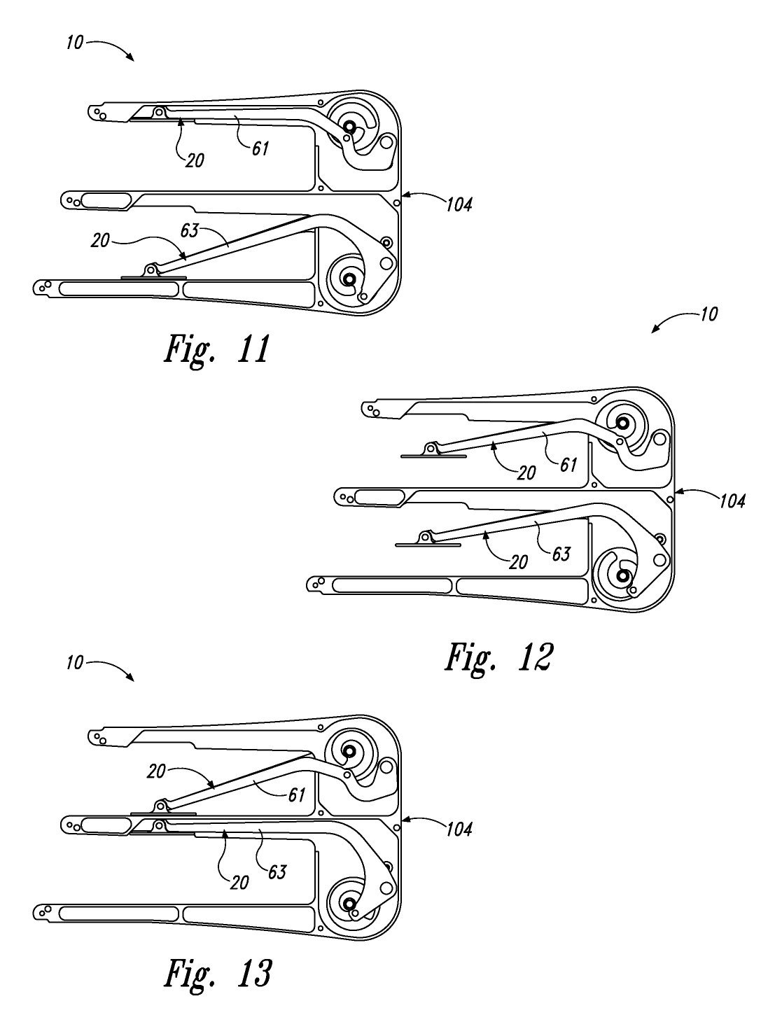

FIG. 11 is a left side view of the sports board mount of FIG. 2 with a left side cover removed. FIG. 11 illustrates an upper clamping member 20 (i.e., first clamping member 61) in a fully retracted position and a lower clamping member 20 (i.e., first bottom clamping member 63) in a fully extended position. Such a configuration of the first clamping member may be generated by retaining upper knob 116 of FIG. 2 at a clockwise, or fully clockwise, rotational orientation and/or by rotating the upper knob in a clockwise direction to place the upper knob in the clockwise, or fully clockwise, rotational orientation. In addition, such a configuration of the first bottom clamping member may be generated by retaining lower knob 144 of FIG. 2 at a counterclockwise, or fully counterclockwise, rotational orientation and/or by rotating the lower knob in a counterclockwise direction to place the lower knob in the counterclockwise, or fully counterclockwise, rotational orientation.

FIG. 12 is a left side view of the sports board mount of FIG. 2 with a left side cover removed. FIG. 12 illustrates the first clamping member 61 and first bottom clamping member 63 in respective intermediate engagement positions. Such a configuration for the first clamping member and the first bottom clamping member may be generated by rotating upper knob 116 and lower knob 144 of FIG. 2 to respective intermediate rotational orientations that are between their respective fully clockwise and fully counterclockwise rotational orientations.

FIG. 13 is a left side view of the sports board mount of FIG. 2 with a left side cover removed. FIG. 13 illustrates first clamping member 61 in a fully extended position and first bottom clamping member 63 in a fully retracted position. Such a configuration of the first clamping member may be generated by retaining upper knob 116 of FIG. 2 at a counterclockwise, or fully counterclockwise, rotational orientation and/or by rotating the upper knob in a counterclockwise direction to place the upper knob in the counterclockwise, or fully counterclockwise, rotational orientation. In addition, such a configuration of the first bottom clamping member may be generated by retaining lower knob 144 of FIG. 2 at a clockwise, or fully clockwise, rotational orientation and/or by rotating the lower knob in a clockwise direction to place the lower knob in the clockwise, or fully clockwise, rotational orientation.

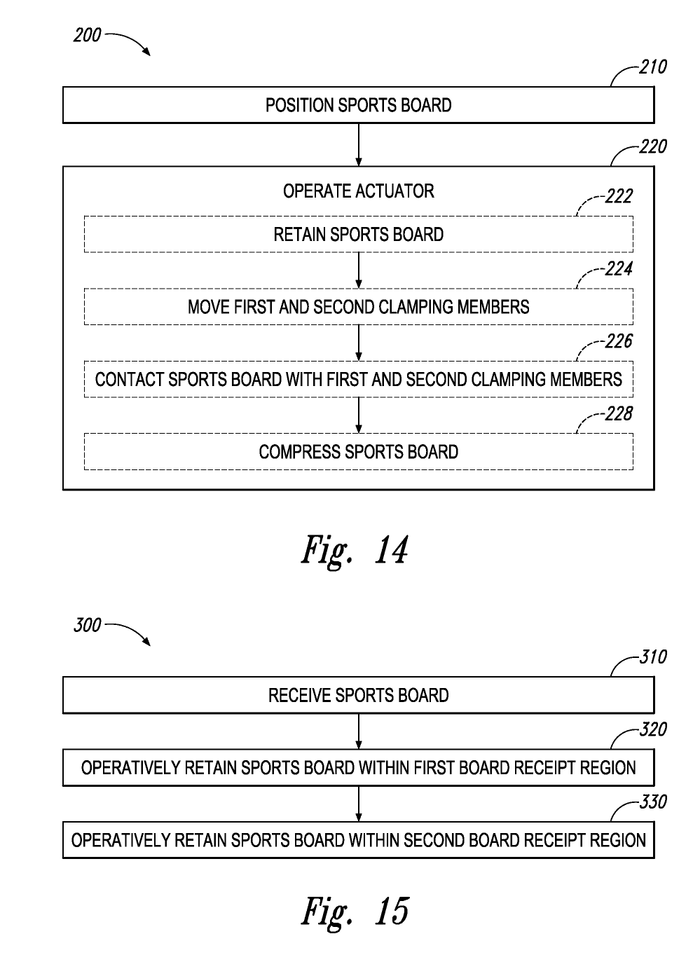

FIG. 14 is a flowchart depicting methods 200, according to the present disclosure, of retaining a sports board within a sports board mount. Methods 200 include positioning the sports board at 210 and operating an actuator at 220.

Positioning the sports board at 210 may include positioning the sports board, or a single sports board, in, or within, a first board receipt region of the sports board mount and also positioning the sports board in, or within a second board receipt region of the sports board mount. The first board receipt region may be formed and/or defined between a first upper arm of the sports board mount and a first lower arm of the sports board mount. The second board receipt region may be formed and/or defined between a second upper arm of the sports board mount and a second lower arm of the sports board mount.

Operating the actuator at 220 may include operatively retaining (or operating the actuator to operatively retain) the sports board within the first board receipt region with a first clamping member of the sports board mount and operatively retaining (or operating the actuator to operatively retain) the sports board within the second board receipt region with a second clamping member of the sports board mount. This is indicated in FIG. 14 at 222. The operatively retaining at 222 may include concurrently, or at least substantially concurrently, retaining the sports board with the first clamping member and with the second clamping member.

The operating at 220 also may include moving both the first clamping member and the second clamping member, as indicated at 224. The moving at 224 may include concurrently moving both the first clamping member and the second clamping member. Additionally or alternatively, the moving at 224 may be responsive, or directly responsive, to the operating at 220. The moving at 224 may include translating both the first clamping member and the second clamping member and/or rotating both the first clamping member and the second clamping member.

The operating at 220 further may include contacting the sports board with both the first clamping member and the second clamping member, as indicated at 226. The contacting at 226 may be responsive, or directly responsive, to the operating at 220.

The operating at 220 also may include compressing the sports board, as indicated at 228. The compressing at 228 may include compressing the sports board between the first clamping member and one of the first upper arm and the first lower arm. The compressing at 228 also may include compressing the sports board between the second clamping member and one of the second upper arm and the second lower arm. The compressing at 228 may be responsive, or directly responsive, to the operating at 220.

FIG. 15 is a flowchart depicting methods 300, according to the present disclosure, of retaining a sports board within a sports board mount. Methods 300 may include receiving the sports board at 310, operatively retaining the sports board within a first board receipt region at 320, and operatively retaining the sports board within a second board receipt region at 330.

Receiving the sports board at 310 may include receiving the sports board in, or within, the first board receipt region of the sports board mount and in, or within, the second board receipt region of the sports board mount. The first board receipt region may be formed and/or defined between a first upper arm of the sports board mount and a first lower arm of the sports board mount. The second board receipt region may be formed and/or defined between a second upper arm of the sports board mount and a second lower arm of the sports board mount.

Operatively retaining the sports board within the first board receipt region at 320 may include operatively retaining with a first clamping member of the sports board mount and may be responsive, or directly responsive, to operation of an actuator by a user of the sports board mount. Operatively retaining the sports board within the second board receipt region at 330 may include operatively retaining with a second clamping member of the sports board mount and may be responsive, or directly responsive, to operation of the actuator by the user.

The operatively retaining at 320 and the operatively retaining at 330 may be performed concurrently, or at least substantially concurrently. The operatively retaining at 320 and the operatively retaining at 330 may be responsive to operation of a single actuator by the user, responsive to a single user action that produces actuation of the single actuator, and/or responsive to a single motion of the actuator by the user.

The operatively retaining at 320 and the operatively retaining at 330 may include translating the first clamping member and the second clamping member responsive to the operation of the actuator by the user. Additionally or alternatively, the operatively retaining at 320 and the operatively retaining at 330 may include rotating the first clamping member and the second clamping member responsive to the operation of the actuator by the user.

The operatively retaining at 320 may include contacting the sports board with the first clamping member and/or compressing the sports board between the first clamping member and one of the first upper arm and the first lower arm. The operatively retaining at 330 may include contacting the sports board with the second clamping member and/or compressing the sports board between the second clamping member and one of the second upper arm and the second lower arm.

In the present disclosure, several of the illustrative, non-exclusive examples have been discussed and/or presented in the context of flow diagrams, or flow charts, in which the methods are shown and described as a series of blocks, or steps. Unless specifically set forth in the accompanying description, it is within the scope of the present disclosure that the order of the blocks may vary from the illustrated order in the flow diagram, including with two or more of the blocks (or steps) occurring in a different order and/or concurrently. It is also within the scope of the present disclosure that the blocks, or steps, may be implemented as logic, which also may be described as implementing the blocks, or steps, as logics. In some applications, the blocks, or steps, may represent expressions and/or actions to be performed by functionally equivalent circuits or other logic devices. The illustrated blocks may, but are not required to, represent executable instructions that cause a computer, processor, and/or other logic device to respond, to perform an action, to change states, to generate an output or display, and/or to make decisions.

As used herein, the term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “comprising” may refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein, the phrase “at least one,” in reference to a list of one or more entities should be understood to mean at least one entity selected from any one or more of the entity in the list of entities, but not necessarily including at least one of each and every entity specifically listed within the list of entities and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” may mean A alone, B alone, C alone, A and B together, A and C together, B and C together, A, B and C together, and optionally any of the above in combination with at least one other entity.

In the event that any patents, patent applications, or other references are incorporated by reference herein and (1) define a term in a manner that is inconsistent with and/or (2) are otherwise inconsistent with, either the non-incorporated portion of the present disclosure or any of the other incorporated references, the non-incorporated portion of the present disclosure shall control, and the term or incorporated disclosure therein shall only control with respect to the reference in which the term is defined and/or the incorporated disclosure was present originally.

As used herein the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa.

As used herein, the phrase, “for example,” the phrase, “as an example,” and/or simply the term “example,” when used with reference to one or more components, features, details, structures, embodiments, and/or methods according to the present disclosure, are intended to convey that the described component, feature, detail, structure, embodiment, and/or method is an illustrative, non-exclusive example of components, features, details, structures, embodiments, and/or methods according to the present disclosure. Thus, the described component, feature, detail, structure, embodiment, and/or method is not intended to be limiting, required, or exclusive/exhaustive; and other components, features, details, structures, embodiments, and/or methods, including structurally and/or functionally similar and/or equivalent components, features, details, structures, embodiments, and/or methods, are also within the scope of the present disclosure.

Examples of board mounts according to the present disclosure and methods of operating the same are described in the following enumerated paragraphs:

A. A sports board mount, comprising:

a body, the body including:
(i) a base configured to be operatively coupled to a structure;
(ii) a first upper arm extending from the base; and
(iii) a first lower arm extending from the base, wherein the first lower arm is spaced below the first upper arm to permit receipt of a first sports board between the first upper arm and the first lower arm;

a first clamping member operatively coupled to selectively extend from one of the first upper arm and the first lower arm, wherein the first clamping member is configured to be selectively moved between a first-clamping-member retracted position and a first-clamping-member range of engagement positions for engagement and securement of the first sports board positioned between the first upper arm and the first lower arm; and

an upper actuator operatively coupled to the first clamping member and configured to selectively move the first clamping member to and from the first-clamping-member retracted position and amongst the first-clamping-member range of engagement positions.

A1. The sports board mount of paragraph A, further comprising:

a second upper arm extending from the base and laterally spaced from the first upper arm;

a second lower arm extending from the base, wherein the second lower arm is spaced below the second upper arm and laterally spaced from the first lower arm to permit receipt of the first sports board between the first upper arm and the second upper arm and between the first lower arm and the second lower arm;

a second clamping member operatively coupled to selectively extend from one of the second upper arm and the second lower arm, wherein the second clamping member is configured to be selectively moved between a second-clamping-member retracted position and a second-clamping-member range of engagement positions for engagement and securement of the first sports board positioned between the second upper arm and the second lower arm.

A1.1. The sports board mount of paragraph A1,

wherein the upper actuator also is operatively coupled to the second clamping member; and

wherein responsive to an input from a user, the upper actuator is configured to selectively move both the first clamping member to and from the first-clamping-member retracted position and amongst the first-clamping-member range of engagement positions and the second clamping member to and from the second-clamping-member retracted position and amongst the second-clamping-member range of engagement positions.

A1.1.1. The sports board mount of paragraph A1.1, wherein the upper actuator is positioned to be accessed and operated from a single lateral side of the sports board mount.

A1.1.2. The sports board mount of any of paragraphs A1-A1.1.1, wherein the first clamping member has a first compliance and the second clamping member has a second compliance, wherein the first compliance and the second compliance are configured to facilitate securement of a sports board having different thicknesses at regions of contact with the first clamping member and the second clamping member.

A1.1.2.1. The sports board mount of paragraph A1.1.2, wherein the first compliance is defined by a material of construction of the first clamping member, and wherein the second compliance is defined by a material of construction of the second clamping member.

A1.1.2.2. The sports board mount of any of paragraphs A1.1.2-A1.1.2.1, wherein the first compliance is defined by a shape of the first clamping member, and wherein the second compliance is defined by a shape of the second clamping member.

A1.1.3. The sports board mount of any of paragraphs A1-A1.1.2.2, wherein the sports board mount further includes an operational linkage that extends between and operatively interconnects the upper actuator, the first clamping member, and the second clamping member.

A1.1.3.1. The sports board mount of paragraph A1.1.3, wherein the operational linkage is configured to move responsive to motion of the upper actuator.

A1.1.3.2. The sports board mount of any of paragraphs A1-A1.1.3.1, wherein the operational linkage includes a torsion spring configured to torsionally interconnect the first clamping member and the second clamping member and to permit limited rotational motion of the first clamping member relative to the second clamping member.

A1.2. The sports board mount of any of paragraphs A1-A1.1.2.2, wherein the first clamping member is operatively coupled to selectively extend from the first upper arm, and wherein the second clamping member is operatively coupled to selectively extend from the second upper arm.

A1.3. The sports board mount of any of paragraphs A1-A1.2, further comprising:

an upper clamping mechanism, including:
(i) an upper axle rotationally supported relative to the body and extending between and rigidly coupled to the first clamping member and to the second clamping member, wherein the upper axle defines an upper pivotal axis of the first clamping member and the second clamping member, and optionally wherein the upper axle includes an upper torsion spring axle;
(ii) the upper actuator;
(iii) an upper cam member rotationally supported by the body and operatively coupled to the upper actuator, wherein the upper cam member includes a channel with opposing cam surfaces; and
(iv) an upper follower positioned within the channel of the upper cam member and engaged with the opposing cam surfaces, wherein the upper follower is operatively coupled to the first clamping member and is spaced away from the upper axle;

wherein, responsive to user input to the upper actuator in a first direction, the upper cam member rotates in a first rotational direction, causing the upper follower to move radially in a first radial direction, causing the first clamping member and the second clamping member to pivot about the upper pivotal axis in a first pivotal direction; and

wherein, responsive to user input to the upper actuator in a second direction, the upper cam member rotates in a second rotational direction, causing the upper follower to move radially in a second radial direction, causing the first clamping member and the second clamping member to pivot about the upper pivotal axis in a second pivotal direction, optionally wherein the second rotational direction is opposed to the first rotational direction, and further optionally wherein the second pivotal direction is opposed to the first pivotal direction.

A1.3.1. The sports board mount of paragraph A1.3, wherein the channel is a spiral-shaped channel.

A2. The sports board mount of any of paragraphs A-A1.3.1, further comprising:

a first bottom arm extending from the base, wherein the first bottom arm is spaced below the first lower arm to permit receipt of a second sports board between the first lower arm and the first bottom arm; and

a first bottom clamping member operatively coupled to selectively extend from one of the first lower arm and the first bottom arm, wherein the first bottom clamping member is configured to be selectively moved between a first-bottom-clamping-member retracted position and a first-bottom-clamping-member range of engagement positions for engagement and securement of the second sports board positioned between the first lower arm and the first bottom arm.

A2.1. The sports board mount of paragraph A2,

wherein the upper actuator also is operatively coupled to the first bottom clamping member; and

wherein responsive to an input from a/the user, the upper actuator is configured to:
(i) selectively move the first clamping member to and from the first-clamping-member retracted position and amongst the first-clamping-member range of engagement positions; and
(ii) selectively move the first bottom clamping member to and from the first-bottom-clamping-member retracted position and amongst the first-bottom-clamping-member range of engagement positions.

A2.1.1 The sports board mount of paragraph A2.1, wherein the first clamping member has a/the first compliance and the first bottom clamping member has a first bottom clamping member compliance, wherein the first compliance and the first bottom clamping member compliance are configured to facilitate securement of two sports boards having different thicknesses at regions of contact with the first clamping member and the first bottom clamping member.

A2.1.1.1. The sports board mount of paragraph A2.1.1, wherein the first compliance is defined by a material of construction of the first clamping member, and wherein the first bottom clamping member compliance is defined by a material of construction of the first bottom clamping member.

A2.1.1.2. The sports board mount of any of paragraphs A2.1.1-A2.1.1.1, wherein the first compliance is defined by a shape of the first clamping member, and wherein the first bottom clamping member compliance is defined by a shape of the first bottom clamping member.

A2.2. The sports board mount of any of paragraphs A2-A2.1.1.2 when depending from paragraph A1, further comprising:

a second bottom arm extending from the base, wherein the second bottom arm is spaced below the second lower arm and laterally spaced from the first bottom arm to permit receipt of the second sports board between the first and second lower arms and the first and second bottom arms; and

a second bottom clamping member operatively coupled to selectively extend from one of the second lower arm and the second bottom arm, wherein the second bottom clamping member is configured to be selectively moved between a second-bottom-clamping-member retracted position and a second-bottom-clamping-member range of engagement positions for engagement and securement of the second sports board between the second lower arm and the second bottom arm.

A2.2.1. The sports board mount of paragraph A2.2 when depending from paragraph A2.1,

wherein the upper actuator is operatively coupled to the second bottom clamping member; and

wherein responsive to an input from a/the user, the upper actuator is configured to selectively move both the first bottom clamping member to and from the first-bottom-clamping-member retracted position and amongst the first-bottom-clamping-member range of engagement positions and the second bottom clamping member to and from the second-bottom-clamping-member retracted position and amongst the second-bottom-clamping-member range of engagement positions.

A2.2.1.1 The sports board mount of paragraph A2.2.1, wherein the first bottom clamping member has a first bottom clamping member compliance and the second bottom clamping member has a second bottom clamping member compliance, wherein the first bottom clamping member compliance and the second bottom clamping member compliance are configured to facilitate securement of a sports board having different thicknesses at regions of contact with the first bottom clamping member and with the second bottom clamping member.

A2.2.1.1.1. The sports board mount of paragraph A2.2.1.1, wherein the first bottom clamping member compliance is defined by a material of construction of the first bottom clamping member, and wherein the second bottom clamping member compliance is defined by a material of construction of the second bottom clamping member.

A2.2.1.1.2. The sports board mount of any of paragraphs A2.2.1.1-A2.2.1.1.1, wherein the first bottom clamping member compliance is defined by a shape of the first bottom clamping member, and wherein the second bottom clamping member compliance is defined by a shape of the second bottom clamping member.

A2.3. The sports board mount of paragraph A2, further comprising:

a bottom actuator operatively coupled to the first bottom clamping member and configured to selectively move the first bottom clamping member to and from the first-bottom-clamping-member retracted position and amongst the first-bottom-clamping-member range of engagement positions.

A2.3.1. The sports board mount of paragraph A2.3 when depending from paragraph A2.2,

wherein the bottom actuator also is operatively coupled to the second bottom clamping member; and

wherein responsive to an input from a/the user, the bottom actuator is configured to selectively move the first bottom clamping member to and from the first-bottom-clamping-member retracted position and amongst the first-bottom-clamping-member range of engagement positions and to selectively move the second bottom clamping member to and from the second-bottom-clamping-member retracted position and amongst the second-bottom-clamping-member range of engagement positions.

A2.3.1.1. The sports board mount of any of paragraphs A2.3-A2.3.1, wherein the bottom actuator is positioned to be accessed and operated from a/the single lateral side of the sports board mount.

A2.3.1.1.1. The sports board mount of paragraph A2.3.1.1 when depending from paragraph A1.1.1, wherein the top and bottom actuators are positioned to be accessed and operated from the same single lateral side of the sports board mount.

A2.3.2. The sports board mount of any of paragraphs A2.3-A2.3.1.1.1, further comprising: a lower clamping mechanism, including:
(i) a lower axle rotationally supported relative to the body and extending between and rigidly coupled to the first bottom clamping member and the second bottom clamping member, wherein the lower axle defines a lower pivotal axis of the first bottom clamping member and the second bottom clamping member, and optionally wherein the lower axle includes a lower torsion spring axle;
(ii) the bottom actuator;
(iii) a lower cam member rotationally supported by the body and operatively coupled to the bottom actuator, wherein the lower cam member includes a lower channel with opposing cam surfaces; and
(iv) a lower follower positioned within the lower channel of the lower cam member and engaged with the opposing cam surfaces, wherein the lower follower is operatively coupled to the first bottom clamping member and is spaced away from the lower axle;

wherein, responsive to user input to the bottom actuator in a first direction, the lower cam member rotates in a first rotational direction, causing the lower follower to move radially in a first radial direction, causing the first bottom clamping member and a/the second bottom clamping member to pivot about the lower pivotal axis in a first pivotal direction; and

wherein, responsive to user input to the bottom actuator in a second direction, the lower cam member rotates in a second rotational direction, causing the lower follower to move radially in a second radial direction, causing the first bottom clamping member and the second bottom clamping member to pivot about the lower pivotal axis in a second pivotal direction.

A2.3.2.1. The sports board mount of paragraph A2.3.2, wherein the lower channel is a spiral-shaped lower channel.

A3. The sports board mount of any of paragraphs A-A2.3.2.1, wherein the upper actuator includes at least one of:

(i) a first knob configured to be selectively grasped and rotated by a/the user; and

(ii) a first lever arm configured to be selectively grasped and pivoted by the user.

A4. The sports board mount of any of paragraphs A2.3-A2.3.2.1, wherein the bottom actuator includes at least one of:

(i) a second knob configured to be selectively grasped and rotated by a/the user; and

(ii) a second lever arm configured to be selectively grasped and pivoted by the user.

A5. The sports board mount of any of paragraphs A-A4, wherein the first clamping member at least one of:

(i) is pivotally coupled relative to the body;

(ii) is linearly translationally coupled relative to the body; and

(iii) includes a first conforming portion configured to at least partially conform to a surface of the first sports board when engaged therewith, optionally wherein the first conforming portion includes a resilient material.

A6. The sports board mount of any of paragraphs A1-A5, wherein the second clamping member at least one of:

(i) is pivotally coupled relative to the body;

(ii) is linearly translationally coupled relative to the body; and

(iii) includes a second conforming portion configured to at least partially conform to a/the surface of the first sports board when engaged therewith, optionally wherein the second conforming portion includes a/the resilient material.

A7. The sports board mount of any of paragraphs A2-A6, wherein the first bottom clamping member at least one of:

(i) is pivotally coupled relative to the body;

(ii) is linearly translationally coupled relative to the body; and

(iii) includes a first bottom conforming portion configured to at least partially conform to a surface of the second sports board when engaged therewith, optionally wherein the first bottom conforming portion includes a/the resilient material.

A8. The sports board mount of any of paragraphs A2.2-A4, wherein the second bottom clamping member at least one of:

(i) is pivotally coupled relative to the body;

(ii) is linearly translationally coupled relative to the body; and

(iii) includes a second bottom conforming portion configured to at least partially conform to a/the surface of the second sports board when engaged therewith, optionally wherein the second bottom conforming portion includes a/the resilient material.

A9. A structure including the sports board mount of any of paragraphs A-A8.

A10. The structure of paragraph A9, wherein the structure includes at least one of a watercraft, a vessel, a boat, a ship, a vehicle, a nonstationary vehicle, an automobile, an off road vehicle, a recreational vehicle, and an aircraft.

B. A sports board mount, comprising:

a body configured to receive a sports board and further configured to be operatively coupled to a structure;

two laterally spaced-apart clamping members, each clamping member configured to be selectively moved relative to the body amongst a range of positions to operatively engage and retain the sports board relative to the body; and

an actuator, optionally positioned on a lateral side of the body, the actuator operatively coupled to the two laterally spaced-apart clamping members and configured to selectively move the two laterally spaced-apart clamping members amongst their respective ranges of positions.

B1. The sports board mount of paragraph B, wherein the sports board mount comprises a single actuator for operative movement of the two laterally spaced-apart clamping members.

B2. The sports board mount of paragraph B, wherein the actuator is a first actuator, the sports board mount further comprising:

a second actuator positioned on a lateral side of the body opposite the first actuator, the second actuator operatively coupled to the clamping members and configured to selectively move the two laterally spaced-apart clamping members amongst their respective ranges of positions, wherein responsive to an input from a user to only one of the first actuator and the second actuator, the clamping members are caused to move amongst their respective ranges of positions.

B3. A structure including the sports board mount of any of paragraphs B-B2.

B4. The structure of paragraph B3, wherein the structure includes at least one of a watercraft, a vessel, a boat, a ship, a vehicle, a nonstationary vehicle, an automobile, an off road vehicle, a recreational vehicle, and an aircraft.

B5. The sports mount of any of paragraphs B-B4 including the subject matter of any of paragraphs A-A10.

C. A method of retaining a sports board within a sports board mount, the method comprising:

positioning the sports board in a first board receipt region of the sports board mount and in a second board receipt region of the sports board mount, wherein the first board receipt region is defined between a first upper arm of the sports board mount and a first lower arm of the sports board mount, and further wherein the second board receipt region is defined between a second upper arm of the sports board mount and a second lower arm of the sports board mount; and

operating an actuator to operatively retain the sports board within the first board receipt region with a first clamping member of the sports board mount and also to operatively retain the sports board within the second board receipt region with a second clamping member of the sports board mount.

C1. The method of paragraph C, wherein the operating includes concurrently, or at least substantially concurrently, retaining the sports board with the first clamping member and with the second clamping member.

C2. The method of any of paragraphs C-C1, wherein the method includes moving both the first clamping member and the second clamping member responsive, and optionally directly responsive, to the operating the actuator.

C3. The method of paragraph C2, wherein the moving includes at least one of:

(i) translating both the first clamping member and the second clamping member; and

(ii) rotating both the first clamping member and the second clamping member.

C4. The method of any of paragraphs C-C3, wherein the method includes contacting the sports board with both the first clamping member and with the second clamping member responsive, and optionally directly responsive, to the operating the actuator.

C5. The method of any of paragraphs C-C4, wherein the method includes compressing the sports board between the first clamping member and one of the first upper arm and the first lower arm responsive, and optionally directly responsive, to the operating the actuator, and further wherein the method includes compressing the sports board between the second clamping member and one of the second upper arm and the second lower arm responsive, and optionally directly responsive, to the operating the actuator.

C6. The method of any of paragraphs C-C5, wherein the sports board mount includes the sports board mount of any of paragraphs A1-B5.

D. A method of retaining a sports board within a sports board mount, the method comprising:

receiving the sports board within a first board receipt region of the sports board mount and in a second board receipt region of the sports board mount, wherein the first board receipt region is defined between a first upper arm of the sports board mount and a first lower arm of the sports board mount, and further wherein the second board receipt region is defined between a second upper arm of the sports board mount and a second lower arm of the sports board mount; and

responsive to operation of an actuator by a user of the sports board mount:

(i) operatively retaining the sports board within the first board receipt region with a first clamping member of the sports board mount; and

(ii) operatively retaining the sports board within the second board receipt region with a second clamping member of the sports board mount.

D1. The method of paragraph D, wherein the method includes concurrently, or at least substantially concurrently, operatively retaining the sports board within the first board receipt region and operatively retaining the sports board within the second board receipt region.

D2. The method of any of paragraphs D-D1, wherein the method includes operatively retaining the sports board within the first board receipt region and operatively retaining the sports board within the second board receipt region responsive to operation of a single actuator by the user.

D3. The method of any of paragraphs D-D2, wherein the method includes operatively retaining the sports board within the first board receipt region and operatively retaining the sports board within the second board receipt region responsive to a single motion of the actuator by the user.

D4. The method of any of paragraphs D-D3, wherein the operatively retaining the sports board within the first board receipt region and the operatively retaining the sports board within the second board receipt region include at least one of:
(i) translating both the first clamping member and the second clamping member responsive to operation of the actuator by the user; and
(ii) rotating both the first clamping member and the second clamping member responsive to operation of the actuator by the user.

D5. The method of any of paragraphs D-D4, wherein the operatively retaining the sports board within the first board receipt region includes contacting the sports board with the first clamping member, and further wherein the operatively retaining the sports board within the second board receipt region includes contacting the sports board with the second clamping member.

D6. The method of any of paragraphs D-D5, wherein the operatively retaining the sports board within the first board receipt region includes compressing the sports board between the first clamping member and one of the first upper arm and the first lower arm, and further wherein the operatively retaining the sports board within the second board receipt region includes compressing the sports board between the second clamping member and one of the second upper arm and the second lower arm.

D7. The method of any of paragraphs D-D6, wherein the sports board mount includes the sports board mount of any of paragraphs A1-35.

### INDUSTRIAL APPLICABILITY

The sports board mounts and methods disclosed herein are applicable to the sporting goods, sports board, and/or sports board mount industries.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower, or equal in scope to the original claims, are also regarded as included within the subject matter of the inventions of the present disclosure.

1. A sports board mount, comprising:
a body configured to receive a sports board and further configured to be operatively coupled to a structure;
two laterally spaced-apart clamping members, each clamping member configured to be selectively moved relative to the body amongst a range of positions to operatively engage and retain the sports board relative to the body; and
an actuator that is operatively coupled to the two laterally spaced-apart clamping members and configured to selectively move the two laterally spaced-apart clamping members amongst their respective ranges of positions.

2. The sports board mount of claim 1, wherein the actuator comprises a single actuator for operative movement of the two laterally spaced-apart clamping members.

3. A sports board mount, comprising:
a body, the body including:
(i) a base configured to be operatively coupled to a structure;
(ii) a first upper arm extending from the base;
(iii) a first lower arm extending from the base, wherein the first lower arm is spaced below the first upper arm to permit receipt of a first sports board between the first upper arm and the first lower arm;
(iv) a second upper arm extending from the base and laterally spaced from the first upper arm; and
(v) a second lower arm extending from the base, wherein the second lower arm is spaced below the second upper arm and laterally spaced from the first lower arm to permit receipt of the first sports board between the second upper arm and the second lower arm;
a first clamping member operatively coupled to selectively extend from one of the first upper arm and the first lower arm, wherein the first clamping member is configured to be selectively moved between a first-clamping-member retracted position and a first-clamping-member range of engagement positions for engagement and securement of the first sports board positioned between the first upper arm and the first lower arm;
a second clamping member operatively coupled to selectively extend from one of the second upper arm and the second lower arm, wherein the second clamping member is configured to be selectively moved between a second-clamping-member retracted position and a second-clamping-member range of engagement positions for engagement and securement of the first sports board positioned between the second upper arm and the second lower arm; and
an upper actuator operatively coupled to the first clamping member and to the second clamping member, wherein, responsive to an input from a user, the upper actuator is configured to selectively move the first clamping member to and from the first-clamping-member retracted position and amongst the first-clamping-member range of engagement positions and concurrently to selectively move the second clamping member to and from the second-clamping-member retracted position and amongst the second-clamping-member range of engagement positions.

4. The sports board mount of claim 3, wherein the upper actuator is positioned to be accessed and operated from a single lateral side of the sports board mount.

5. The sports board mount of claim 3, wherein the first clamping member has a first compliance and the second clamping member has a second compliance, wherein the first compliance and the second compliance are configured to facilitate securement of a sports board having different thicknesses at regions of contact with the first clamping member and the second clamping member.

6. The sports board mount of claim 5, wherein the first compliance is defined by a material of construction of the first clamping member and the second compliance is defined by a material of construction of the second clamping member.

7. The sports board mount of claim 5, wherein the first compliance is defined by a shape of the first clamping member and the second compliance is defined by a shape of the second clamping member.

8. The sports board mount of claim 3, wherein the first clamping member is operatively coupled to selectively extend from the first upper arm, and wherein the second clamping member is operatively coupled to selectively extend from the second upper arm.

9. The sports board mount of claim 3, further comprising:
an upper clamping mechanism, including:
(i) an upper axle rotationally supported relative to the body and extending between and rigidly coupled to the first clamping member and to the second clamping member, wherein the upper axle defines an upper pivotal axis of the first clamping member and the second clamping member;
(ii) the upper actuator;
(iii) an upper cam member rotationally supported by the body and operatively coupled to the upper actuator, wherein the upper cam member includes a channel with opposing cam surfaces; and
(iv) an upper follower positioned within the channel of the upper cam member and engaged with the opposing cam surfaces, wherein the upper follower is operatively coupled to the first clamping member and is spaced away from the upper axle;
wherein, responsive to user input to the upper actuator in a first direction, the upper cam member rotates in a first rotational direction, causing the upper follower to move radially in a first radial direction, causing the first clamping member and the second clamping member to pivot about the upper pivotal axis in a first pivotal direction; and
wherein, responsive to user input to the upper actuator in a second direction, the upper cam member rotates in a second rotational direction, causing the upper follower to move radially in a second radial direction, causing the first clamping member and the second clamping member to pivot about the upper pivotal axis in a second pivotal direction.

10. The sports board mount of claim 9, wherein the channel is a spiral-shaped channel.

11. The sports board mount of claim 3, further comprising:
a first bottom arm extending from the base, wherein the first bottom arm is spaced below the first lower arm to permit receipt of a second sports board between the first lower arm and the first bottom arm; and
a first bottom clamping member operatively coupled to selectively extend from one of the first lower arm and the first bottom arm, wherein the first bottom clamping member is configured to be selectively moved between a first-bottom-clamping-member retracted position and a first-bottom-clamping-member range of engagement positions for engagement and securement of the second sports board positioned between the first lower arm and the first bottom arm.

12. The sports board mount of claim 11,
wherein the upper actuator also is operatively coupled to the first bottom clamping member; and
wherein responsive to an input from the user, the upper actuator is configured to:
(i) selectively move the first clamping member to and from the first-clamping-member retracted position and amongst the first-clamping-member range of engagement positions; and
(ii) selectively move the first bottom clamping member to and from the first-bottom-clamping-member retracted position and amongst the first-bottom-clamping-member range of engagement positions.

13. The sports board mount of claim 12, wherein the first clamping member has a first compliance and the first bottom clamping member has a first bottom clamping member compliance, wherein the first compliance and the first bottom clamping member compliance are configured to facilitate securement of two sports boards having different thicknesses at regions of contact with the first clamping member and the first bottom clamping member.

14. The sports board mount of claim 12, further comprising:
a second bottom arm extending from the base, wherein the second bottom arm is spaced below the second lower arm and laterally spaced from the first bottom arm to permit receipt of the second sports board between the first and second lower arms and the first and second bottom arms; and
a second bottom clamping member operatively coupled to selectively extend from one of the second lower arm and the second bottom arm, wherein the second bottom clamping member is configured to be selectively moved between a second-bottom-clamping-member retracted position and a second-bottom-clamping-member range of engagement positions for engagement and securement of the second sports board between the second lower arm and the second bottom arm.

15. The sports board mount of claim 14,
wherein the upper actuator is operatively coupled to the second bottom clamping member; and
wherein responsive to an input from the user, the upper actuator is configured to selectively move both the first bottom clamping member to and from the first-bottom-clamping-member retracted position and amongst the first-bottom-clamping-member range of engagement positions and the second bottom clamping member to and from the second-bottom-clamping-member retracted position and amongst the second-bottom-clamping-member range of engagement positions.

16. The sports board mount of claim 12, further comprising:
a bottom actuator operatively coupled to the first bottom clamping member and configured to selectively move the first bottom clamping member to and from the first-bottom-clamping-member retracted position and amongst the first-bottom-clamping-member range of engagement positions.

17. The sports board mount of claim 3, wherein the upper actuator includes at least one of:
(i) a first knob configured to be selectively grasped and rotated by the user; and
(ii) a first lever arm configured to be selectively grasped and pivoted by the user.

18. The sports board mount of claim 3, wherein the first clamping member at least one of:
(i) is pivotally coupled relative to the body;
(ii) is linearly translationally coupled relative to the body; and
(iii) includes a first conforming portion configured to at least partially conform to a surface of the first sports board when engaged therewith.

19. A structure including the sports board mount of claim 3, wherein the structure includes at least one of a watercraft, a vessel, a boat, a ship, a vehicle, a nonstationary vehicle, an automobile, an off road vehicle, a recreational vehicle, and an aircraft.

20. A method of retaining a sports board within a sports board mount, the method comprising:
positioning the sports board in a first board receipt region of the sports board mount and in a second board receipt region of the sports board mount, wherein the first board receipt region is defined between a first upper arm of the sports board mount and a first lower arm of the sports board mount, and further wherein the second board receipt region is defined between a second upper arm of the sports board mount and a second lower arm of the sports board mount; and
operating an actuator to operatively retain the sports board within the first board receipt region with a first clamping member of the sports board mount and also to operatively retain the sports board within the second board receipt region with a second clamping member of the sports board mount.
